(19) United States
(12) Patent Application Publication
(10) Pub. No.: US 2025/0078566 A1
(43) Pub. Date: Mar. 6, 2025

(54) IMAGE PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Bingchuan LI, Beijing (CN); Zili YI, Beijing (CN)

(21) Appl. No.: 18/725,684

(22) PCT Filed: Dec. 26, 2022
(86) PCT No.: PCT/CN2022/141795

§ 371 Date: Jun. 28, 2024

(30) Foreign Application Priority Data
Dec. 29, 2021 (CN) 202111641195.4

(51) Int. Cl. G06V 40/16

(52) U.S. Cl. CPC G06V 40/171

(57) ABSTRACT

Provided are an image processing method and apparatus, an electronic device, and a storage medium. The image processing method comprises: obtaining data to be processed; and processing the data to be processed on the basis of a target facial attribute determination model to obtain a target facial image corresponding to the data to be processed, wherein at least one target feature in the target facial image matches with at least one corresponding preset facial feature.

### CROSS-REFERENCE TO RELATED APPLICATION(S)

This application claims priority to Chinese Patent Application No. 202111641195.4, filed with China National Intellectual Property Administration on Dec. 29, 2021, which is incorporated herein by reference in its entirety.

### FIELD

The disclosure relates to the field of computer technology, and for example, relates to an image processing method, an apparatus, an electronic device, and a storage medium.

### BACKGROUND

With the development of technology, more and more application software is applied to lives of users, gradually enriching leisure time of the users, such as short video applications. The users may record lives through videos, photos, and other means, and upload them to the short video applications. To enhance the interest of video and photo content, corresponding effects are often added to objects in images.

The technology of adding effects usually involves using a method of image retouching through software to add effects to objects in images, such as making an object turn head. According to the method, when the effect is added, distortions of the limbs, the face, etc. of the object are likely to be caused, leading to a problem of poor effect addition.

### SUMMARY

The disclosure provides an image processing method, an apparatus, an electronic device, and a storage medium, so as to achieve the addition of facial effects to an object, ensuring that a generated image is optimally matched with effects of facial changes presented in reality, thereby improving the accuracy of facial effect addition.

In a first aspect, the disclosure provides an image processing method. The method includes:
acquiring data to be processed, where the data to be processed includes Gaussian noise or an image to be converted; and
processing the data to be processed based on a target facial attribute determination model to obtain a target facial image corresponding to the data to be processed, wherein at least one target feature in the target facial image is matched with corresponding at least one preset facial feature.

In a second aspect, the disclosure further provides an image processing apparatus. The apparatus includes:
a data acquisition module, configured to acquire data to be processed, wherein the data to be processed includes Gaussian noise or an image to be converted; and
a target image determination module, configured to process the data to be processed based on a target facial attribute determination model to obtain a target facial image corresponding to the data to be processed, where at least one target feature in the target facial image is matched with corresponding at least one preset facial feature.

In a third aspect, the disclosure further provides an electronic device. The device includes:
one or more processors; and
a storage apparatus, configured to store one or more programs;
when the one or more programs are executed by the one or more processors, the one or more processors implement the image processing method as stated above.

In a fourth aspect, the disclosure further provides a computer-readable storage medium, storing a computer program. The program, when executed by a processor, implements the above image processing method.

In a fifth aspect, the disclosure further provides a computer program product, including a computer program carried on a non-transitory computer-readable medium. The computer program includes program code configured to implement the above image processing method.

### BRIEF DESCRIPTION OF THE DRAWINGS

FIG. 1 is a schematic flowchart of an image processing method according to Embodiment 1 of the disclosure;

FIG. 2 is a schematic diagram of a target facial image matched with a preset facial feature according to Embodiment 1 of the disclosure;

FIG. 3 is a schematic flowchart of an image processing method according to Embodiment 2 of the disclosure;

FIG. 4 is a structural schematic diagram of a target facial attribute determination model according to Embodiment 2 of the disclosure;

FIG. 5 is a schematic flowchart of an image processing method according to Embodiment 3 of the disclosure;

FIG. 6 is a structural schematic diagram of a facial attribute determination model to be trained according to Embodiment 3 of the disclosure;

FIG. 7 is a schematic flowchart of an image processing method according to Embodiment 4 of the disclosure;

FIG. 8 is a structural block diagram of an image processing apparatus according to Embodiment 5 of the disclosure; and

FIG. 9 is a structural schematic diagram of an electronic device according to Embodiment 6 of the disclosure.

### DETAILED DESCRIPTION OF EMBODIMENTS

Embodiments of the disclosure will be described with reference to the accompanying drawings. Although the accompanying drawings show some embodiments of the disclosure, the disclosure may be implemented in various forms, and these embodiments are provided for understanding the disclosure. The accompanying drawings and the embodiments of the disclosure are for exemplary purposes only.

A plurality of steps recorded in method implementations in the disclosure may be performed in different orders and/or in parallel. In addition, the method implementations may include additional steps and/or omit the execution of the shown steps. The scope of the disclosure is not limited in this aspect.

The term “including” and variations thereof used in this specification are open-ended, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description.

Concepts such as “first”, and “second” mentioned in the disclosure are only for distinguishing different apparatuses, modules, or units, and are not intended to limit the order or relation of interdependence of functions performed by these apparatuses, modules, or units. Modifications such as “a” and “a plurality of” mentioned in the disclosure are indicative rather than limiting, and those skilled in the art should understand that unless otherwise specified in the context, it should be interpreted as “one or more”.

Before introducing the technical solution, application scenarios may be first exemplarily described. The technical solution of the disclosure may be applied to any scenario that requires effect displays. For example, effects may be displayed during video calls; or, a streamer object may be displayed with effects in live broadcast scenarios. The technical solution may also be applied to a situation where effects are displayed on images corresponding to captured objects in the video shooting process. For example, in short video shooting scenarios, the captured images may be processed to be effect images, and then the processed effect images may be displayed with effects. The technical solution may also be applied to a process of static image shooting, such as a situation where after a camera of a terminal device shoots an image, the captured image is processed to be an effect image for effect displays.

### Embodiment 1

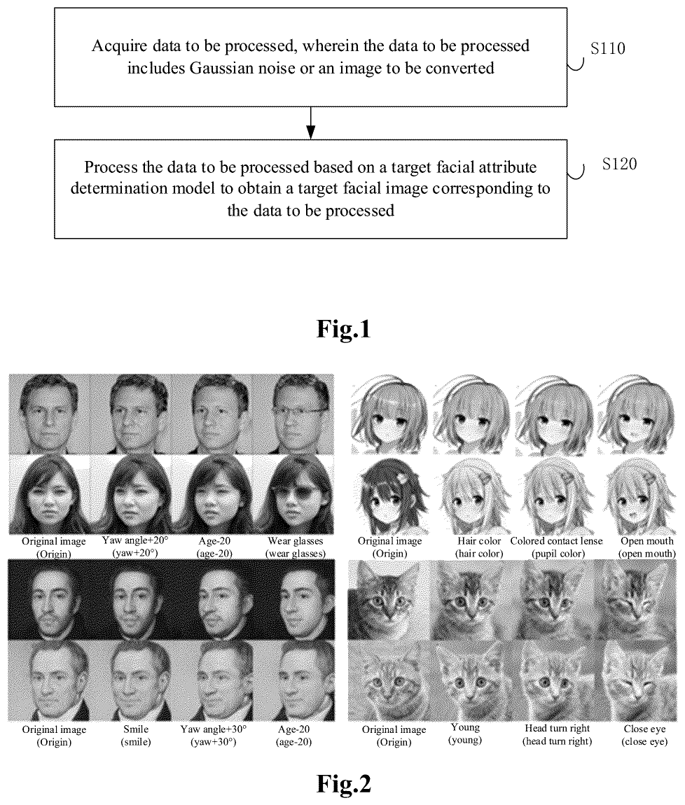

FIG. 1 is a schematic flowchart of an image processing method according to Embodiment 1 of the disclosure. This embodiment of the disclosure is applicable to any image display scenario supported by the Internet, and is used for a situation where a facial image of a target object is processed to be an effect image to be displayed. The method may be executed by an image processing apparatus. The apparatus may be implemented in the form of software and/or hardware, and is, for example, implemented by an electronic device. The electronic device may be a mobile terminal, a personal computer (PC) terminal, a server, or the like. Any image display scenario is typically implemented through cooperation of a client and the server. The method provided by this embodiment may be executed by a server side, or the client, or through cooperation of the client and the server side.

As shown in FIG. 1, the method in this embodiment includes:

S110: data to be processed is acquired, where the data to be processed includes Gaussian noise or an image to be converted.

Various applicable scenarios have been briefly described above, which will not be elaborated herein. An apparatus for executing the image processing method provided by this embodiment of the disclosure may be integrated into application software supporting an image processing function. The software may be installed in an electronic device. For example, the electronic device may be a mobile terminal, or a PC terminal, etc. The application software may be a type of software for image/video processing. Various types of application software are not enumerated, as long as image/video processing may be achieved.

The data to be processed may be data needing to be processed, which may be Gaussian noise or an image. The Gaussian noise may be randomly sampled noise, and may include at least one type of noise such as fluctuation noise, cosmic noise, thermal noise, and shot noise. The image to be converted may be an image acquired based on the application software, or an image pre-stored by the application software from a storage space. In the application scenario, the image to be converted may be acquired in real time or periodically. For example, in a live broadcast scenario or a video shooting scenario, a camera device collects corresponding images of a target in a target scenario in real time, and in these cases, the images acquired by the camera device are taken as images to be converted. Correspondingly, the image to be converted may include a target subject. The target subject may be a user, a pet, a flower and plant, etc. Video frames corresponding to a captured video may also be processed. For example, a target subject corresponding to the captured video may be preset. When the target subject is detected from an image corresponding to the video frame, the image corresponding to the video frame may be taken as the image to be converted, such that the target subject in each video frame in the video may be subsequently subject to facial feature processing.

There may be one or more target subjects in the same shooting scenario. The technical solution provided by the disclosure may be adopted to determine an effect display image, whether there is one or more target subjects.

In any video shooting and live broadcast scenarios, images including target subjects may be acquired in real time or at intervals to be as images to be converted. Meanwhile, a device may also be utilized for randomly collecting noise to obtain Gaussian noise. The Gaussian noise and the image to be converted may be taken as inputs of a model to train the model.

In this embodiment, original facial data with corresponding features need to be added to a facial image is determined as the data to be processed.

S120: the data to be processed is processed based on a target facial attribute determination model to obtain a target facial image corresponding to the data to be processed.

The target facial attribute determination model may be pre-trained. The target facial attribute determination model may process the input Gaussian noise or image to be converted to obtain an image after corresponding features have been added to a face in the Gaussian noise or image to be converted. Before training the target facial attribute determination model, facial features added to a user by the model may be pre-determined, and in this case, the facial features are taken as preset facial features. An image output by the target facial attribute determination model may be taken as the target facial image, and in this case, the preset facial features are added to the target facial image.

In this embodiment, the preset facial features may include at least one of a facial feature about wearing at least one type of accessories, facial features of different age stages, facial features of different angles, facial features of different hairstyles, facial features of different hair color combinations, and facial features of different facial expressions.

The worn accessories may be glasses, sunglasses, face stickers, etc., and features corresponding to the worn accessories may be taken as the preset facial features. The facial features of different age stages may be facial features corresponding to object subjects of different age groups. Different age groups may be age groups divided by increasing or decreasing age based on originally-collected image as a reference. Different age groups may be a youth age group, a middle age group, and an elderly age group. The facial features of different angles may be features corresponding to different orientations of the face of the object subject. For example, different angles may also be based on a corresponding facial angle of the body in the originally-collected image, which may yaw 20 degrees to the left, 20 degrees to the left, 20 degrees downward, etc. based on a reference, and the facial features corresponding to these angles may also be used as the preset facial features. For example, if the target facial attribute determination model is required to output an image with effects such as wearing glasses, adding 20 years to the age, and yawing 20 degrees to the left, these facial features may be taken as the preset facial features. The preset facial features may be the facial features of different hairstyles, such as long hair, short hair, curly hair, and straight hair. The facial features of different hair color combinations may be various colors such as purple, white, and black, and may also be combined features of different hairstyles and different colors. The facial features of different facial expressions may include smile, anger, annoyance, and other facial expression features.

In this embodiment, the data to be processed may be input to the pre-trained target facial attribute determination model, and the corresponding features may be added to the image corresponding to the data to be processed, such that the facial image with the added features corresponding to the data to be processed may be output, namely the target facial image.

For example, the preset facial features may include at least one of facial features corresponding to an image of the face yawing 20° to the right) (yaw+20°), age increased by 20 years (age+20), wearing glasses (wear glasses), smiling (smile), face yawing 30° to the right) (yaw+30°), and age decreased by 20 years (age−20). After inputting an original image (Origin) into the model, a corresponding schematic diagram may be obtained, as shown in FIG. 2.

According to the technical solution of this embodiment of the disclosure, by acquiring the data to be processed, the data to be processed is processed based on the target facial attribute determination model to obtain the target facial image with the added effects corresponding to the data to be processed. The problems that in the related art, when an effect image is generated using an image retouching technology, the reality of the obtained effect image is low, causing poor user experience are solved. The technical effects that the corresponding facial features are added to the face of the target object in the data to be processed to obtain high effect reality, enhance the richness and interest of video image content, and improve the use experience of the user are achieved.

### Embodiment 2

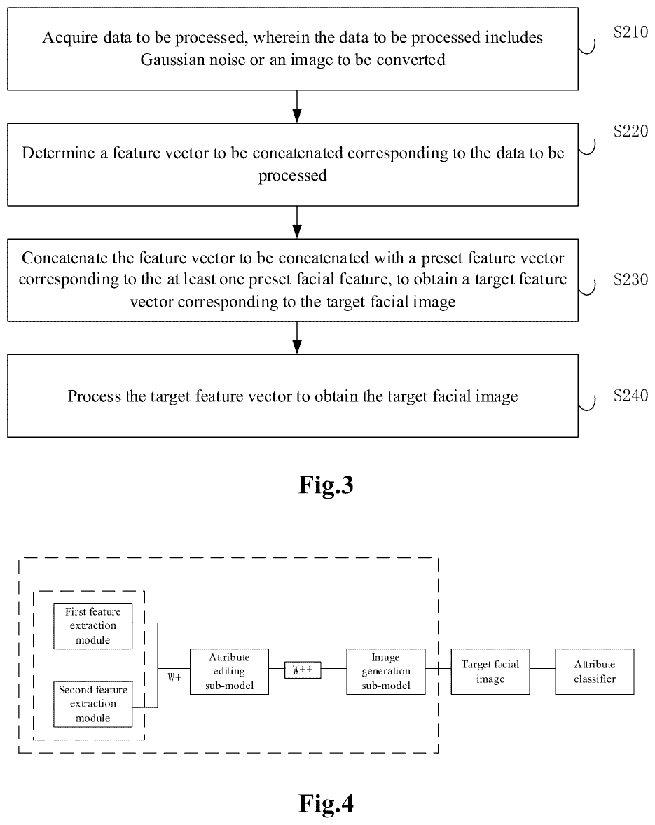

FIG. 3 is a schematic flowchart of an image processing method according to Embodiment 2 of the disclosure. Based on the foregoing embodiment, S120 is described, and for an implementation, reference may be made to the technical solution in this embodiment. Technical terms that are the same with or corresponding to those in the foregoing embodiment are not repeated herein.

As shown in FIG. 3, the method includes the following steps:

S210: data to be processed is acquired, where the data to be processed includes Gaussian noise or an image to be converted.

S220: a feature vector to be concatenated corresponding to the data to be processed is determined.

The target facial attribute determination model includes a feature preprocessing sub-model, an attribute editing sub-model, and an image generation sub-model. The data to be processed is processed through the three sub-models to obtain a target facial image corresponding to the data to be processed.

The feature preprocessing sub-model may be configured to extract corresponding features. The attribute editing sub-model may refer to a model for adding preset facial features to the extracted features. The image generation sub-model may refer to a model that performs image generation based on features output by the attribute editing sub-model. The feature vector to be concatenated refers to a vector output by the feature preprocessing sub-model, and a feature vector extracted by the feature preprocessing sub-model may be taken as the feature vector to be concatenated.

Data to be processed may be taken as an input of the feature preprocessing sub-model. The data is subject to feature extraction processing by the model, so as to obtain a feature vector corresponding to the data to be processed, and the feature vector may be taken as the feature vector to be concatenated.

For example, a structural schematic diagram of the target facial attribute determination model may be shown in FIG. 4. The model may include the feature preprocessing sub-model, the attribute editing sub-model, and the image generation sub-model. The feature preprocessing sub-model includes a first feature extraction module and a second feature extraction module.

The data to be processed may include Gaussian noise or an image to be converted to ensure data processing accuracy. Different processing methods may be adopted based on different data, and such that algorithm modules used based on the different processing methods perform targeted processing on the different data. The processing methods may be referred to in the following description.

The feature preprocessing sub-model includes a first feature extraction module and a second feature extraction module, and the step of determining a feature vector to be concatenated corresponding to the data to be processed based on the feature preprocessing sub-model includes: if the data to be processed is the Gaussian noise, a feature vector to be concatenated corresponding to the Gaussian noise is determined based on the first feature extraction module; and if the data to be processed is the image to be converted, a feature vector to be concatenated corresponding to the image to be converted is determined based on the second feature extraction module.

The first feature extraction module is configured to extract the feature vector corresponding to the Gaussian noise. The second feature extraction module is configured to extract the feature vector corresponding to the facial attribute in the image to be converted.

In this embodiment, to separately process the Gaussian noise and the image to be converted, the two feature extraction modules may be preset in the feature preprocessing sub-model to separately perform corresponding processing on the two types of data. Correspondingly, data of the Gaussian noise as the data to be processed may be input to the first feature extraction module, and the module may process the Gaussian noise to obtain the feature vector to be concatenated corresponding to the Gaussian noise. Data of the image to be converted as the data to be processed may be input to the second feature extraction module, and the module may process the image to be converted to obtain the feature vector to be concatenated corresponding to the image to be converted. Correspondingly, the feature vectors to be concatenated corresponding to all the data to be processed may be obtained.

Exemplarily, continue to refer to FIG. 4, the Gaussian noise may be processed based on the first feature extraction module to output the feature vector to be concatenated corresponding to the Gaussian noise. For example, the first feature extraction module may be Mapping Network model. The image to be converted may be processed based on the second feature extraction module to output the feature vector to be concatenated corresponding to the image to be converted. For example, the second feature extraction module may be an Encoder model. For example, by fixing generator parameters of a trained stylegan model, the Encoder model is trained. After model training is completed, a facial image may be input and encoded through an Encoder, and then, through a stylegan generator, the facial image may be reconstructed. The output feature vector to be concatenated may be taken as W+ for later model input.

In practical application, after the data is input to the model, the type of the data input to the model may be determined based on a data interface, and which model for processing is determined based on the data type. If the data to be processed is the Gaussian noise, the Gaussian noise may be taken as an input of the first feature extraction module, and the module may output the feature vector to be concatenated corresponding to the Gaussian noise. If the data to be processed is the image to be converted, the image to be converted may be taken as an input of the second feature extraction module, and the module may output the feature vector to be concatenated corresponding to the image to be converted.

S230: the feature vector to be concatenated is concatenated with a preset feature vector corresponding to the at least one preset facial feature to obtain a target feature vector corresponding to the target facial image.

The preset feature vector refers to a vector corresponding to the preset facial feature, and the target feature vector may be a feature vector obtained after concatenating the feature vector to be concatenated with the preset feature vector.

In this embodiment, to add a corresponding effect to the data to be processed, concatenation processing may be performed on the feature vector to be concatenated and the feature vector corresponding to the preset facial features, and then the corresponding target feature vector obtained after adding the facial features to the data to be processed may be obtained, thereby generating the target facial image with the effect based on the target feature vector. For example, after the feature vector to be concatenated is input to the pre-trained attribute editing sub-model, the sub-model may perform concatenation processing on the feature vector to be concatenated and the preset feature vector corresponding to the preset facial features. For example, a feature vector A and a feature vector B may be concatenated into A-B, correspondingly, a concatenated feature vector may be obtained after the concatenation processing, and the concatenated feature vector may be taken as the target feature vector corresponding to the target facial image.

Exemplarily, continue to refer to FIG. 4, the attribute editing sub-model may be a Dynamic Network model. For example, the Dynamic Network model may be utilized for performing concatenation processing on the feature vector to be concatenated and the preset feature vector, and output W++ is the target feature vector corresponding to the target facial image. For example, the input preset feature vector is encoded by a multilayer perceptron (MLP), and then is subjected to multiplication and addition operations with the input feature vector to be concatenated through two fully-connected layers (FCs) and one activation function sigmoid, thereby obtaining the target feature vector. An identifier corresponding to the preset feature vector may be set in the Dynamic Network model.

The feature vector to be concatenated may be taken as an input of the attribute editing sub-model, the sub-model may concatenate the feature vector to be concatenated with the preset feature vector corresponding to at least one preset facial feature, so as to obtain the target feature vector corresponding to the target facial image with the preset facial features added, such that the target facial image with the effect may be subsequently generated based on the target feature vector.

S240: the target feature vector is processed to obtain the target facial image.

In this embodiment, to generate the image with the corresponding effect added to the data to be processed, the corresponding target feature vector obtained after concatenating the feature vector to be concatenated with the preset feature vector may be input to the pre-trained image generation sub-model, and the model may perform reconstruction processing on the target feature vector to output the target facial image corresponding to the target feature vector.

Exemplarily, continue to refer to FIG. 4, the image generation sub-model may be a Generator model. For example, the Generator model may be utilized for processing the target feature vector to output the target facial image corresponding to the target feature vector.

After the target facial image is obtained, optimization processing may be performed on parameters in the target facial attribute determination model according to an original image actually input to the model and the target facial image output by the model. For example, a trained model attribute classifier may be added, and the attribute classifier may be a model for extracting and classifying image attribute features. The attribute classifier may be utilized for extracting feature data in the target facial image and determining facial features of the target facial image, so as to verify whether the preset facial features are added to an image output by the model. Accordingly, if the preset facial features are not added to the image output by the model, parameters in the model may be corrected so as to improve accuracy of the model.

After the target facial image is obtained, the method further includes: at least one target attribute corresponding to the target facial image is determined based on the pre-trained attribute classifier, so as to correct model parameters in the target facial attribute determination model based on the at least one target attribute, where the at least one target attribute is matched with an attribute identifier of the at least one preset facial feature.

The attribute identifier may refer to an identifier corresponding to the preset facial feature. In other words, the preset facial feature may be represented by the corresponding identifier. For example, the age feature is denoted by A₁, the angle feature is denoted by A₂, the wearing-glasses feature is denoted by A₃, therefore, the identifiers such as A₁, A₂, and A₃ may be taken as the attribute identifiers of the corresponding features, and the target attribute may also be identifier information corresponding to the preset facial feature.

In this embodiment, to optimize the parameters in the target facial attribute determination model, the output target facial image and a corresponding theoretical facial image with an effect added may be compared. Correspondingly, the attribute feature corresponding to the output target facial image may be compared with the added effect feature, and therefore the model parameters in a classification model to be trained are corrected based on calculation about whether the attribute feature corresponding to the target facial image includes the added effect feature.

The target facial image may be input to the pre-trained attribute classifier, and then the classifier may perform feature extraction processing on the target facial image to output the feature attribute corresponding to the target facial image, namely the target attribute. The feature attribute output at present is compared with the attribute identifier of the preset facial feature to calculate a comparison error value, and then the model parameters in the model may be adjusted based on the comparison error value.

Exemplarily, continue to refer to FIG. 4, the attribute classifier may be a residual networks (ResNet) model. For example, the target facial image may be input to the attribute classifier, the image is subjected to feature extraction processing through the classifier, and the target attribute corresponding to the target facial image may be output.

The target facial image may be taken as an input of the attribute classifier, and the classifier may output the corresponding target attribute. An algorithm may also be utilized for performing error processing on the target attribute corresponding to the image and the attribute identifier of the preset facial feature, such that the model parameters of the target facial attribute determination model may be corrected based on an obtained error result, thereby improving training accuracy of the target facial attribute determination model.

According to the technical solution of this embodiment of the disclosure, by acquiring the data to be processed such as the Gaussian noise or image to be converted, the data to be processed is processed based on the target facial attribute determination model to obtain the target facial image with the added effects corresponding to the different types of data. Meanwhile, after the target facial image is obtained, the parameters in the model are corrected based on the target facial image to achieve the technical effects that the accuracy of the model is improved, then, the reality of the added effects is improved, the effects of enhancing richness and interest of the video image content are achieved, and the use experience of the user is improved.

### Embodiment 3

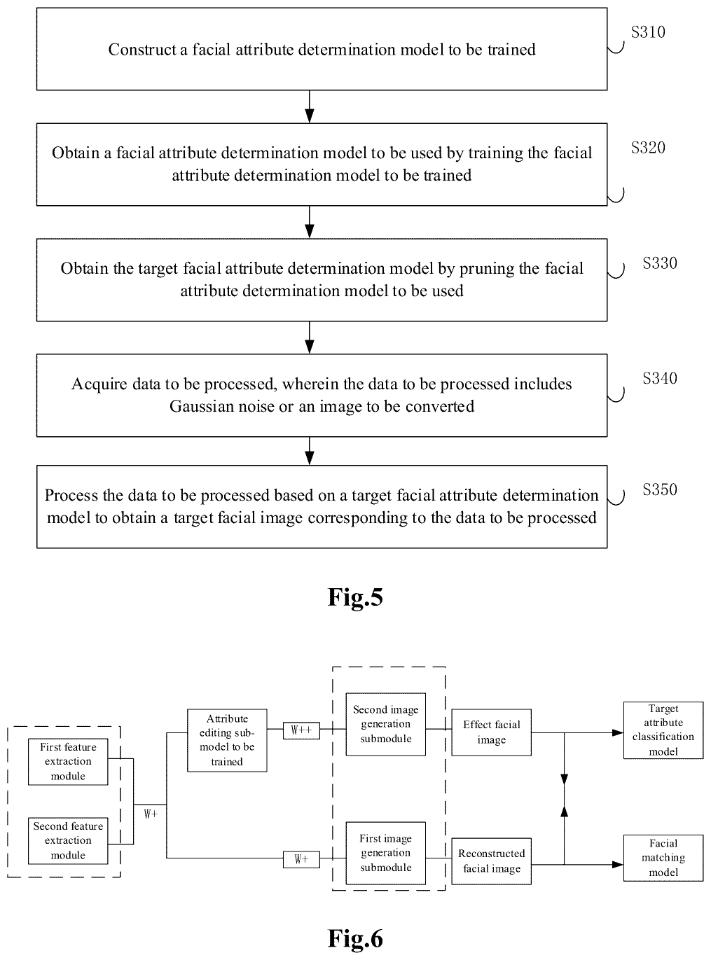

FIG. 5 is a schematic diagram of an image processing method according to Embodiment 3 of the disclosure. Based on the foregoing embodiment, a facial attribute determination model to be trained may also be pre-constructed, and a target facial attribute determination model is obtained by training the facial attribute determination model to be trained. For an implementation, reference may be made to the technical solution of this embodiment. Technical terms that are the same with or corresponding to those in the foregoing embodiment are not repeated herein.

As shown in FIG. 5, the method includes the following steps:

S310: a facial attribute determination model to be trained is constructed.

The facial attribute determination model to be trained refers to a model in which model parameters are set to default values, and the model needs to be trained to obtain a target facial attribute determination model.

In this embodiment, to obtain the target facial attribute determination model capable of determining facial attribute features with high accuracy, training may be performed based on the pre-constructed facial attribute determination model to be trained, such that after the training of the facial attribute determination model to be trained is completed, the final applicable facial attribute determination model may be obtained, namely the target facial attribute determination model.

In this embodiment, the step of constructing a facial attribute determination model to be trained includes: the facial attribute determination model to be trained is constructed based on an attribute editing sub-model to be trained, a pre-trained target adversarial model, a pre-trained target attribute classification model, and a pre-trained facial matching model, where the target attribute classification model is configured to determine facial features of images output by the target adversarial model; and the facial matching model is configured to determine a matching degree of the facial images output based on the target adversarial model, and the target adversarial model is configured to output two facial images, in which one of the facial images is matched with the preset facial feature set in the attribute editing sub-model to be trained.

The target adversarial model includes: a feature preprocessing sub-model and an image generation sub-model. The feature preprocessing sub-model includes a first feature extraction module. The image generation sub-model includes a first image generation submodule and a second image generation submodule. The feature preprocessing sub-model further includes a second feature extraction module.

The target adversarial model may be a stylegan model. The target attribute classification model (resnet model) is configured to determine facial features of an image output by the second image generation submodule. The facial matching model (face recognition model) is configured to determine a matching degree of facial images output by the first image generation submodule and the second image generation submodule. The first feature extraction module (Mapping Network model) is configured to extract a feature vector corresponding to Gaussian noise. The second feature extraction module (Encoder model) is configured to extract a feature vector corresponding to a facial attribute in an image. The first image generation submodule (Generator model) is configured to determine an image corresponding to a feature vector output by the feature preprocessing sub-model. The second image generation submodule (Generator model) is configured to determine an image corresponding to a feature vector output by the attribute editing sub-model to be trained. The attribute editing sub-model to be trained (Dynamic Network model) is configured to concatenate the feature vector output by the feature preprocessing sub-model and a preset feature vector. For the attribute editing sub-model needing to be trained, the attribute editing sub-model has an output result not reaching an expected result in this case, which needs to be trained, such that an output result of the trained model is consistent with the expected result, and after training is completed, an applicable attribute editing sub-model may be obtained. For example, an image code (w code) may be obtained through random noise or an image encoder, and two branches of a stylegan generator are designed. One branch directly generates a facial image img1 through the trained stylegan generator; and the other branch generates a facial image img2 with an edited attribute through the attribute editing sub-model to be trained (an input to an editing module is an attribute value, e.g., inputting 1 for wearing glasses, inputting 0 for not wearing glasses, inputting 1 for smiling, and inputting 0 for not smiling) and the trained stylegan generator. The img1 and img2 are input to the pre-trained target attribute classification model and the pre-trained facial matching model, such that the attribute editing sub-model to be trained may be subsequently trained by calculating differences in attributes and identifiers (Identifier, ids) between the two images as a loss.

Before constructing the facial attribute determination model to be trained, a large number of facial images may be collected and labeled with attributes, such as whether to wear glasses or not. The resnet model is utilized for training an attribute classifier to obtain a target attribute classification model. A facial recognition model is pre-trained to obtain the facial matching model.

Explanations are performed in conjunction with FIG. 6, training data may be input to the feature preprocessing sub-model (the first feature extraction module or the second feature extraction module) to obtain a corresponding feature vector. The feature vector is taken as an input of the attribute editing sub-model to be trained, and a feature vector to be processed may be obtained after the feature vector and the preset feature vector are concatenated. The feature vector to be processed is taken as an input of the second image generation submodule to output an effect facial image, and in this case, there may be a certain deviation between the effect facial image and the preset facial feature. The feature vector is taken as an input of the first image generation submodule to obtain a facial image corresponding to the feature vector. The effect facial image and the facial image are respectively taken as inputs of the target attribute classification model and the facial matching model to obtain feature differences and a facial matching degree of the two images.

S320: a facial attribute determination model to be used is obtained by training the facial attribute determination model to be trained.

The facial attribute determination model to be used refers to a model obtained after training the facial attribute determination model to be trained.

After sample data is obtained, the sample data is utilized for training the facial attribute determination model to be trained to obtain the facial attribute determination model to be used.

S330: the target facial attribute determination model is obtained by pruning the facial attribute determination model to be used.

In this embodiment, to reduce model redundancy, pruning may be performed on a part of module that is actually not used in the facial attribute determination model to be used, and the model obtained after pruning is taken as the target facial attribute determination model.

The target attribute classification model, the facial matching model, and the first image generation sub-model in the facial attribute determination model to be used are removed to obtain the target facial attribute determination model.

S340: data to be processed is acquired, where the data to be processed includes Gaussian noise or an image to be converted.

S350: the data to be processed is processed based on a target facial attribute determination model to obtain a target facial image corresponding to the data to be processed.

According to the technical solution of this embodiment of the disclosure, by acquiring the data to be processed such as the Gaussian noise or image to be converted, the data to be processed is processed based on the target facial attribute determination model to obtain the target facial image with the added effect corresponding to the data to be processed. Meanwhile, the facial attribute determination model to be trained is constructed based on different types of models, and the high-precision facial attribute determination model to be used is obtained based on training the constructed facial attribute determination model to be trained. After the facial attribute determination model to be used is pruned, the target facial attribute determination model is obtained, such that the accuracy of the target facial attribute determination model and the efficiency of effect adding are improved, and then the reality of the effect added to the image is high.

### Embodiment 4

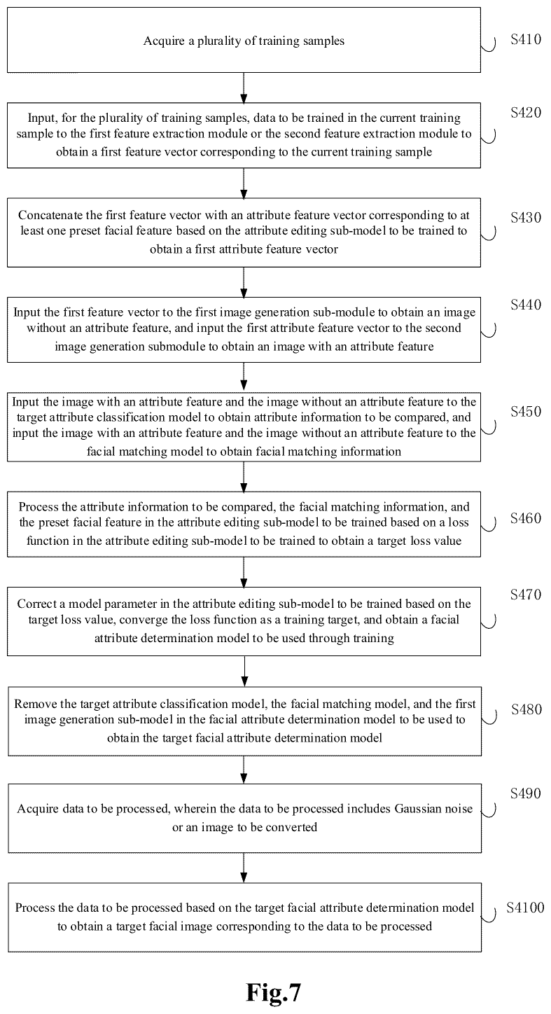

FIG. 7 is a schematic flowchart of an image processing method according to Embodiment 4 of the disclosure. Based on the foregoing embodiment, the facial attribute determination model to be used is refined by training the facial attribute determination model to be trained. For an implementation, reference may be made to the technical solution of this embodiment. Technical terms that are the same with or corresponding to those in the foregoing embodiment are not repeated herein.

As shown in FIG. 7, the method includes the following steps:

S410: a plurality of training samples are obtained.

Before obtaining a facial attribute determination model to be used through training, the training samples need to be obtained first, and the model is trained based on the training samples. To improve the accuracy of the model, as many diverse training samples as possible may be acquired.

The training sample includes data to be trained. The training sample may be a sample for training the model, and an output result of the model may be consistent with an expected result by adjusting parameter values of the model in the training process. The data to be trained may be data for training the model, which may be Gaussian noise, such as Gaussian-sampled random noise. It may also be images. For example, facial images corresponding to a user subject at different angles of sight may be generated by capturing images of a user subject based on different angles of sight, these images may be taken as the data to be trained, and correspondingly, a plurality of training samples may be obtained. For example, in a practical application, a large number of facial images may be collected as training samples. The facial images are utilized for training the stylegan model, such that after model training is completed, the stylegan generator may generate different types of facial images by inputting Gaussian-sampled random noise z-N (0,1).

The plurality of training samples may be stored in a preset database, such that the plurality of training samples in the database may be extracted through an interface.

S420: for the plurality of training samples, the data to be trained in the current training sample is input to the first feature extraction module or the second feature extraction module to obtain a first feature vector corresponding to the current training sample.

When a feature vector corresponding to each training sample needs to be determined, determining the feature vector of any training sample may be processed as determining the feature vector of the current training sample, such that one of the training samples is taken as the current training sample to be described. The first feature vector refers to a feature vector output by the first feature extraction module or the second feature extraction module. For example, after the current training sample is input to the first feature extraction module or the second feature extraction module, the feature vector extracted by the module may be taken as the first feature vector.

Because the data to be trained in the training samples is different, which may be Gaussian noise or images, the data to be trained may be differentially processed based on the first feature extraction module and the second feature extraction module. For example, the data to be trained in the current training sample may be input to a feature preprocessing sub-model. If the data to be trained is the Gaussian noise, the Gaussian noise may be processed based on the first feature extraction module, and a feature vector corresponding to the Gaussian noise may be obtained. If the data to be trained is an image, the image may be processed based on the second feature extraction module to obtain a feature vector corresponding to the image. Both the feature vectors output by the first feature extraction module and the second feature extraction module may be taken as the first feature vector corresponding to the current training sample.

S430: the first feature vector is concatenated with an attribute feature vector corresponding to at least one preset facial feature based on the attribute editing sub-model to be trained to obtain a first attribute feature vector.

The attribute feature vector may be a vector representation corresponding to the preset facial feature, and the feature vector corresponding to any preset facial feature may be taken as the attribute feature vector. The first attribute feature vector may be a feature vector obtained after concatenating the first feature vector with the attribute feature vector, and the vector output by the attribute editing sub-model to be trained may be taken as the first attribute feature vector.

The first feature vector corresponding to the current training sample may be taken as the input of the attribute editing sub-model to be trained, the sub-model may concatenate the first feature vector with the attribute feature vector corresponding to the preset facial feature. Then, the corresponding first attribute feature vector with the added preset facial feature may be output, and accordingly, a facial image with an effect may be subsequently generated based on the first attribute feature vector to adjust model parameters.

S440: the first feature vector is input to the first image generation submodule to obtain an image without an attribute features; and the first attribute feature vector is input to the second image generation submodule to obtain an image with an attribute feature.

The image without an attribute feature may be an image without an effect from the facial images, and the image output by the first image generation submodule may be taken as the image without an attribute feature. The image with an attribute feature may be an image with an effect from the facial images, and the image output by the second image generation submodule may be taken as the image with an attribute feature.

The first feature vector corresponding to the current training sample may be taken as the input of the first image generation submodule, the model may perform image reconstruction on the first feature vector, and in this case, the first feature vector is not processed by an attribute editing model to be trained, there is no feature added, and the model may output the image without attribute features. Meanwhile, the first attribute feature vector corresponding to the current training sample may also be input to the second image generation submodule, and therefore, the first attribute feature vector is a vector processed with an effect added, and then the model may output the image with an attribute feature.

S450: the image with an attribute feature and the image without an attribute feature are input to the target attribute classification model to obtain attribute information to be compared; and the image with an attribute feature and the image without an attribute feature are input to the facial matching model to obtain facial matching information.

The attribute information to be compared may be image facial features output by the target attribute classification model. The facial matching information may be a facial image matching degree output by the facial matching model.

The image with an attribute feature and the image without an attribute feature corresponding to the current training sample may be taken as the input of the target attribute classification model, and facial features corresponding to the two images may be output, namely the attribute information to be compared. The image with an attribute feature and the image without attribute features may be taken as the input of the facial matching model, and a matching degree corresponding to the two images may be output, namely the facial matching information.

S460: the attribute information to be compared, the facial matching information, and the preset facial feature in the attribute editing sub-model to be trained are processed based on a loss function in the attribute editing sub-model to be trained to obtain a target loss value.

The target loss value may be used for representing a loss between the attribute information to be compared and the preset facial feature and a loss between the facial matching information.

The loss function in the attribute editing sub-model to be trained may be utilized for performing loss processing on the attribute information to be compared and the preset facial feature, so as to calculate a loss value between them. The loss function may also be utilized for performing loss processing on the facial matching information so as to calculate a corresponding loss value. Correspondingly, all the calculated loss values may be fused to obtain a fused loss value. The loss value may be taken as a target loss value, such that the model parameters in the model may be corrected based on the target loss value.

S470: model parameters in the attribute editing sub-model to be trained are corrected based on the target loss value, the loss function is converged as a training target, and the facial attribute determination model to be used is obtained through training.

The preset loss function may be converged as the training target. When it is determined that the preset loss function of the attribute editing sub-model to be trained is converged, it indicates that an adjustment result satisfies a solution requirement, the trained model is obtained, and therefore the facial attribute determination model to be used is obtained.

In this embodiment, an attribute feature addition technology may be utilized for processing the first feature vector corresponding to the current training sample, and the attribute editing sub-model to be trained may output the first attribute feature vector corresponding to the current training sample, such that the image with an attribute feature corresponding to the current training sample is generated based on the first attribute feature vector. Because the model parameters in the attribute editing sub-model to be trained are not corrected, there is a corresponding difference between the obtained image with an attribute feature and an image obtained after features are actually added to the image without an attribute feature corresponding to the current training sample, processing may be performed based on the corresponding attribute information to be compared, the facial matching information, and the preset facial feature of the two types of images corresponding to the current training sample, an error value may be determined, and the model parameters in the attribute editing sub-model to be trained may be corrected based on the error value.

The loss function in the attribute editing sub-model to be trained may be utilized for comparing the attribute information to be compared corresponding to the current training sample with a preset attribute value to calculate the loss value, a similar error value corresponding to the facial matching information may be calculated as well. Then, the target loss value may be calculated based on the loss value and the similar error value, thereby correcting the model parameters of the attribute editing sub-model to be trained according to an obtained loss result. A training error of the loss function, namely a loss parameter may be taken as a condition for detecting whether the loss function reaches convergence at present, such as whether the training error is less than a preset error or whether an error variation trend tends to be stable, or whether the number of current iterations is equal to a preset number of times. If it is detected that the convergence condition is satisfied, for example, the training error of the loss function is less than the preset error or the error variation tends to be stable, which indicates that training of the attribute editing sub-model to be trained is finished, and in this case, iterative training may be stopped. If it is detected that the convergence condition is not satisfied at present, training sample data may be acquired to continue training the attribute editing sub-model to be trained until the training error of the loss function is within a preset range. When the training error of the loss function converges, it may be considered that the attribute editing sub-model to be trained is trained, such that the first feature vector is input to the trained attribute editing sub-model to be trained, the model may accurately concatenate the attribute feature vector for the first feature vector, and therefore the image with facial features may be generated.

S480: the target attribute classification model, the facial matching model, and the first image generation sub-model in the facial attribute determination model to be used are removed to obtain the target facial attribute determination model.

In this embodiment, for the above determined facial attribute determination model to be used, the model not only includes the feature preprocessing sub-model and the second image generation submodule, but also includes the first image generation submodule, the target attribute classification model, and the facial matching model. To achieve the effect of generating the facial image with the effect in the case of fast data processing and the low requirement for computing power of a terminal device, the first image generation submodule, the target attribute classification model, and the facial matching model in the facial attribute determination model to be used may be removed. That is, the models that are not used in the application are removed. For example, after the facial attribute determination model to be used is trained, only branches of the attribute editing sub-model are retained, and an edited facial image is generated by inputting the attribute value.

S490: data to be processed is acquired, where the data to be processed includes Gaussian noise or an image to be converted.

S4100: the data to be processed is processed based on the target facial attribute determination model to obtain a target facial image corresponding to the data to be processed.

According to the technical solution of this embodiment of the disclosure, by acquiring the data to be processed such as the Gaussian noise or image to be converted, the data to be processed is processed based on the target facial attribute determination model to obtain the target facial image with the added effect corresponding to the data to be processed. Meanwhile, the training samples are utilized for training the facial attribute determination model to be trained to continuously optimize the model parameters in the attribute editing sub-model to be trained, thereby obtaining the facial attribute determination model to be used. After the facial attribute determination model to be used is pruned, the target facial attribute determination model is obtained, such that the accuracy of the target facial attribute determination model and the efficiency of effect adding are improved, and then the reality of the effect added to the image is high.

### Embodiment 5

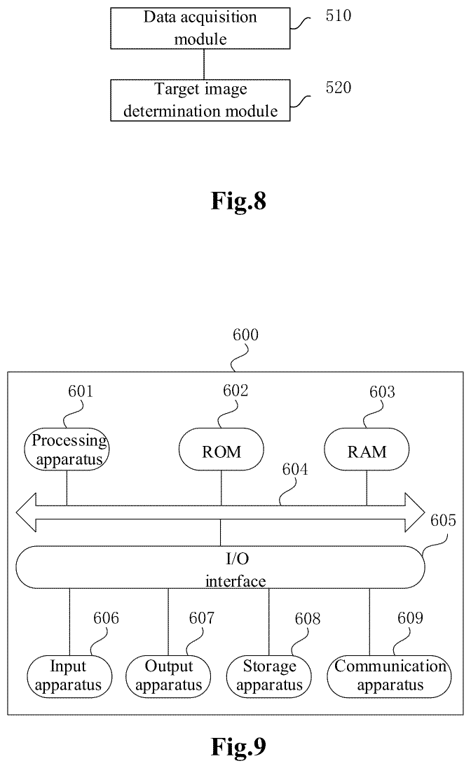

FIG. 8 is a structural block diagram of an image processing apparatus according to Embodiment 5 of the disclosure. The image processing apparatus may execute the image processing method provided by any embodiment of the disclosure, and has corresponding functional modules and effects for executing the method. As shown in FIG. 8, the apparatus includes: a data acquisition module 510 and a target image determination module 520.

The data acquisition module 510 is configured to acquire data to be processed, where the data to be processed includes Gaussian noise or an image to be converted. The target image determination module 520 is configured to process the data to be processed based on a target facial attribute determination model to obtain a target facial image corresponding to the data to be processed, where at least one target feature in the target facial image is matched with corresponding at least one preset facial feature.

Based on the above technical solution, the target image determination module 520 includes a feature vector to be concatenated determination unit, a target feature vector obtaining unit, and a target facial image obtaining unit.

The feature vector to be concatenated determination unit is configured to determine a feature vector to be concatenated corresponding to the data to be processed. The target feature vector obtaining unit is configured to concatenate a preset feature vector corresponding to the at least one preset facial feature for the feature vector to be concatenated to obtain a target feature vector corresponding to the target facial image. The target facial image obtaining unit is configured to process the target feature vector to obtain the target facial image.

Based on the above technical solution, the feature preprocessing sub-model includes a first feature extraction module and a second feature extraction module. The feature vector to be concatenated determination unit includes a first feature vector to be concatenated determination unit and a second feature vector to be concatenated determination unit.

The first feature vector to be concatenated determination unit is configured to determine, based on the first feature extraction module, a feature vector to be concatenated corresponding to the Gaussian noise if the data to be processed is the Gaussian noise. The second feature vector to be concatenated determination unit is configured to determine, based on the second feature extraction module, a feature vector to be concatenated corresponding to the image to be converted if the data to be processed is the image to be converted.

Based on the above technical solution, the apparatus further includes: a target facial attribute determination model parameter correction module.

The target facial attribute determination model parameter correction module is configured to determine, based on a pre-trained attribute classifier, at least one target attribute corresponding to the target facial image, so as to correct model parameters in the target facial attribute determination model based on the at least one target attribute, where the at least one target attribute is matched with an attribute identifier of the at least one preset facial feature.

Based on the above technical solution, the apparatus further includes: a facial attribute determination model to be trained construction module.

The facial attribute determination model to be trained construction module is configured to construct the facial attribute determination model to be trained based on an attribute editing sub-model to be trained, a pre-trained target adversarial model, a pre-trained target attribute classification model, and a pre-trained facial matching model, where the target attribute classification model is configured to determine facial features of images output by the target adversarial model; and the facial matching model is configured to determine a matching degree of the facial images output based on the target adversarial model, and the target adversarial model is configured to output two facial images, and one of the facial images is matched with a preset facial feature set in the attribute editing sub-model to be trained.

Based on the above technical solution, the target adversarial model includes: a feature preprocessing sub-model and an image generation sub-model. The feature preprocessing sub-model includes a first feature extraction module. The image generation sub-model includes a first image generation submodule and a second image generation submodule. The feature preprocessing sub-model further includes a second feature extraction module.

Based on the above technical solution, the facial attribute determination model to be trained construction module further includes a facial attribute determination model to be trained construction unit.

The facial attribute determination model to be trained construction unit is configured to take an output result of the first feature extraction module or the second feature extraction module as an input of the attribute editing sub-model to be trained and the first image generation submodule, take an output of the attribute editing sub-model to be trained as an input of the second image generation submodule, and take an output of the first image generation submodule and an output of the second image generation submodule as inputs of the target attribute classification model and the facial matching model to construct the facial attribute determination model to be trained.

Based on the above technical solution, a facial attribute determination model to be used obtaining unit further includes: a training sample obtaining subunit, a first feature vector obtaining subunit, a first attribute feature vector obtaining subunit, an attribute feature image obtaining subunit, an information obtaining subunit, a target loss value determination subunit, and a facial attribute determination model to be used obtaining subunit.

The training sample obtaining subunit is configured to obtain a plurality of training samples, where the training sample includes data to be trained. The first feature vector obtaining subunit is configured to input, for the plurality of training samples, the data to be trained in the current training sample to the first feature extraction module or the second feature extraction module to obtain a first feature vector corresponding to the current training sample. The first attribute feature vector obtaining subunit is configured to concatenate the first feature vector with an attribute feature vector corresponding to at least one preset facial feature based on the attribute editing sub-model to be trained to obtain a first attribute feature vector. The attribute feature image obtaining subunit is configured to input the first feature vector to the first image generation submodule to obtain an image without an attribute feature, and input the first attribute feature vector to the second image generation submodule to obtain an image with an attribute feature. The information obtaining subunit is configured to input the image with an attribute feature and the image without attribute features to the target attribute classification model to obtain attribute information to be compared, and input the image with an attribute feature and the image without attribute features to the facial matching model to obtain facial matching information. The target loss value determination subunit is configured to process the attribute information to be compared, the facial matching information, and a preset attribute value in the attribute editing sub-model based on a loss function in the attribute editing sub-model to be trained to obtain a target loss value. The facial attribute determination model to be used obtaining subunit is configured to correct model parameters in the attribute editing sub-model to be trained based on the target loss value, converge the loss function as a training target, and obtain the facial attribute determination model to be used through training.

Based on the above technical solution, a target facial attribute determination model obtaining unit includes a target facial attribute determination model obtaining subunit.

The target facial attribute determination model obtaining subunit is configured to remove the target attribute classification model, the facial matching model, and the second image generation sub-model in the facial attribute determination model to be used to obtain the target facial attribute determination model.

Based on the above technical solution, the preset facial features include at least one of a facial feature about wearing at least one type of accessories, facial features of different age stages, facial features of different angles, facial features of different hairstyles, facial features of different hair color combinations, and facial features of different facial expressions.

According to the technical solution of this embodiment of the disclosure, by acquiring the data to be processed including the Gaussian noise or image to be converted, the data to be processed is processed based on the target facial attribute determination model to obtain the target facial image with the added effects corresponding to the data to be processed. The problems that in the related art, when an effect image is generated using an image retouching technology, the reality of the obtained effect image is low causing poor user experience are solved. The technical effects that the corresponding facial features are added to the face of the target object in the data to be processed to obtain high effect reality, enhance the richness and interest of video image content, and improve the use experience of the user are achieved.

The image processing apparatus provided by this embodiment of the disclosure may execute the image processing method provided by any embodiment of the disclosure, and has the corresponding functional modules and beneficial effects for executing the method.

The various units and modules included in the above apparatus are only divided according to functional logics, but are not limited to the above division, as long as the corresponding functions may be achieved; and in addition, the names of the plurality of functional units are only for the convenience of distinguishing each other, and are not intended to limit the scope of protection of this embodiment of the disclosure.

### Embodiment 6

FIG. 9 is a structural schematic diagram of an electronic device according to Embodiment 6 of the disclosure. Referring to FIG. 9 as below, FIG. 9 illustrates a structural schematic diagram of an electronic device (e.g., a terminal device or a server in FIG. 9) 600 applicable to implementing embodiments of the disclosure. The terminal device in this embodiment of the disclosure may include but not limited to mobile terminals such as a mobile phone, a notebook computer, a digital radio receiver, a personal digital assistant (PDA), a portable Android device (PAD), a portable media player (PMP), and a vehicle-mounted terminal (e.g., a vehicle-mounted navigation terminal), and fixed terminals such as a digital television (TV) and a desk computer. The terminal device 600 shown in FIG. 9 is merely an example, which should not impose any limitations on functions and application ranges of this embodiment of the disclosure.

As shown in FIG. 9, the electronic device 600 may include a processing apparatus (e.g., a central processing unit and a graphics processing unit) 601, which may perform various appropriate actions and processing according to programs stored on a read-only memory (ROM) 602 or loaded from a storage apparatus 608 into a random access memory (RAM) 603. The RAM 603 further stores various programs and data required for the operation of the electronic device 600. The processing apparatus 601, the ROM 602, and the RAM 603 are connected to one another through a bus 604. An input/output (I/O) interface 605 is also connected to the bus 604.

Typically, the following apparatuses may be connected to the I/O interface 605: an input apparatus 606, including, for example, a touchscreen, a touchpad, a keyboard, a mouse, a camera, a microphone, an accelerometer, and a gyroscope; an output apparatus 607, including, for example, a liquid crystal display (LCD), a speaker, and a vibrator; the storage apparatus 608, including, for example, a magnetic tape and a hard drive; and a communication apparatus 609. The communication apparatus 609 may allow the electronic device 600 to be in wireless or wired communication with other devices for data exchange. Although FIG. 9 illustrates the electronic device 600 with various apparatuses, and it is not necessary to implement or have all the shown apparatuses. Alternatively, more or fewer apparatuses may be implemented or provided.

According to this embodiment of the disclosure, the foregoing process described with reference to the flowchart may be implemented as a computer software program. For example, an embodiment of the disclosure includes a computer program product including a computer program carried on a non-transitory computer-readable medium. The computer program includes program code for executing the method shown in the flowchart. In this embodiment, the computer program may be downloaded and installed from the network by the communication apparatus 609, or installed from the storage apparatus 608, or installed from the ROM 602. The computer program, when executed by the processing apparatus 601, performs the above functions limited in the method in this embodiment of the disclosure.

The names of messages or information exchanged between multiple apparatuses in the implementations of the disclosure are provided for illustrative purposes only, and are not intended to limit the scope of these messages or information.

The electronic device provided by this embodiment of the disclosure and the image processing method provided by the foregoing embodiment belong to the same concept, and for technical details not described in detail in this embodiment, reference may be made to the foregoing embodiment. This embodiment and the foregoing embodiment have the same effects.

### Embodiment 7

Embodiment 7 of the disclosure provides a computer storage medium, storing a computer program. The program, when executed by a processor, implements the image processing method provided by the foregoing embodiments.

The computer-readable medium in the disclosure may be a computer-readable signal medium, or a computer-readable storage medium, or any combination thereof. For example, the computer-readable storage medium may include but not limited to: electrical, magnetic, optical, electromagnetic, infrared, or semiconductor systems, apparatuses, or devices, or any combination thereof. Examples of the computer-readable storage medium may include but not limited to: an electrical connection with one or more wires, a portable computer disk, a hard drive, a RAM, a ROM, an erasable programmable read-only memory (EPROM or a flash memory), fiber optics, a portable compact disc read-only memory (CD-ROM), an optical storage device, a magnetic storage device, or any proper combination of the above. In the disclosure, the computer-readable storage medium may be any tangible medium including or storing a program, and the program may be used by an instruction execution system, apparatus, or device, or used in conjunction with the instruction execution system, apparatus, or device. However, in the disclosure, the computer-readable signal medium may include data signals propagated in a baseband or propagated as a part of a carrier wave, which carry computer-readable program code. The propagated data signals may have a plurality of forms, including but not limited to electromagnetic signals, optical signals, or any proper combination of the above. The computer-readable signal medium may be any computer-readable medium other than the computer-readable storage medium. The computer-readable signal medium may send, propagate, or transmit the program used by the instruction execution system, apparatus, or device, or used in conjunction with the instruction execution system, apparatus, or device. The program code included in the computer-readable medium may be transmitted by any proper medium including but not limited to a wire, an optical cable, radio frequency (RF), etc., or any proper combination of the above.

In some implementations, the client and the server may communicate using any currently known or future-developed network protocols such as a hypertext transfer protocol (HTTP), and may also be in communication connection with digital data in any form or medium (e.g., a communication network). For example, the communication network includes a local area network (LAN), a wide area network (WAN), Internet work (e.g., Internet), a peer-to-peer network (e.g., an ad hoc peer-to-peer network), and any currently known or future-developed networks.

The computer-readable medium may be included in the electronic device; and may separately exist without being assembled in the electronic device.

The computer-readable medium carries one or more programs. The one or more programs, when executed by the electronic device, cause the electronic device to:
acquire data to be processed, where the data to be processed includes Gaussian noise or an image to be converted; and process the data to be processed based on a target facial attribute determination model to obtain a target facial image corresponding to the data to be processed, where at least one target feature in the target facial image is matched with corresponding at least one preset facial feature.

The computer program code for executing the operations of the disclosure may be written in one or more programming languages or a combination thereof. The programming languages include but not limited to object-oriented programming languages such as Java, Smalltalk, C++, as well as conventional procedural programming languages such as “C” or similar programming languages. The program code may be executed entirely or partially on a user computer, executed as a standalone software package, executed partially on the user computer and partially on a remote computer, or entirely executed on the remote computer or server. In the case of involving the remote computer, the remote computer may be connected to the user computer via any type of network, including a LAN or WAN, or may be connected to an external computer (e.g., utilizing an Internet service provider for Internet connectivity).

The flowcharts and block diagrams in the accompanying drawings illustrate system architectures, functions, and operations possibly implemented by the system, method and computer program product according to the various embodiments of the disclosure. In this regard, each block in the flowcharts or block diagrams may represent a module, a program segment, or a portion of code, and the module, program segment, or portion of code includes one or more executable instructions for implementing specified logical functions. It should be noted that in some alternative implementations, functions marked in the blocks may also occur in an order different from that marked in the drawings. For example, two consecutively-shown blocks may actually be executed in parallel basically, but sometimes may also be executed in a reverse order, which depends on involved functions. It should be further noted that each block in the block diagrams and/or flowcharts as well as a combination of the blocks in the block diagrams and/or flowcharts may be implemented by using a dedicated hardware-based system that executes specified functions or operations, or using a combination of special hardware and computer instructions.

The units described in the embodiments of the disclosure may be implemented through software or hardware. The name of the unit does not limit the unit in a certain case. For example, a first acquisition unit may also be described as “a unit for acquiring at least two Internet protocol addresses”.

The functions described above in this specification may be at least partially executed by one or more hardware logic components. For example, exemplary hardware logic components that may be used include but not limited to a field programmable gate array (FPGA), an application specific integrated circuit (ASIC), application specific standard parts (ASSPs), a system on chip (SOC), a complex programmable logic device (CPLD), etc.

In the context of the disclosure, a machine-readable medium may be a tangible medium that may contain or store a program, and the program may be used by the instruction execution system, apparatus, or device, or used in conjunction with the instruction execution system, apparatus, or device. The machine-readable medium may be a machine-readable signal medium or a machine-readable storage medium. The machine-readable medium may include but not limited to: electronic, magnetic, optical, electromagnetic, infrared, or semiconductor systems, apparatuses, or devices, or any proper combination of the above. Examples of the machine-readable storage medium may include: an electrical connection based on one or more wires, a portable computer disk, a hard drive, a RAM, a ROM, an EPROM or a flash memory, fiber optics, a CD-ROM, an optical storage device, a magnetic storage device, or any proper combination of the above.

According to one or more embodiments of the disclosure, Example 1 provides an image processing method. The method includes:
acquiring data to be processed, where the data to be processed includes Gaussian noise or an image to be converted; and
processing the data to be processed based on a target facial attribute determination model to obtain a target facial image corresponding to the data to be processed, where at least one target feature in the target facial image is matched with corresponding at least one preset facial feature.

According to one or more embodiments of the disclosure, Example 2 provides an image processing method, further including:
processing the data to be processed based on a target facial attribute determination model to obtain a target facial image corresponding to the data to be processed includes:
determining a feature vector to be concatenated corresponding to the data to be processed;
concatenating the feature vector to be concatenated with a preset feature vector corresponding to the at least one preset facial feature to obtain a target feature vector corresponding to the target facial image; and
processing the target feature vector to obtain the target facial image.

According to one or more embodiments of the disclosure, Example 3 provides an image processing method, further including:
determining a feature vector to be concatenated corresponding to the data to be processed includes:
determining a feature vector to be concatenated corresponding to the Gaussian noise based on a first feature extraction module, based on a determination that the data to be processed is the Gaussian noise; and
determining a feature vector to be concatenated corresponding to the image to be converted based on a second feature extraction module, based on a determination that the data to be processed is the image to be converted.

According to one or more embodiments of the disclosure, Example 4 provides an image processing method, further including:
after obtaining a target facial image corresponding to the data to be processed, the method further includes:
determining at least one target attribute corresponding to the target facial image based on a pre-trained attribute classifier, to correct a model parameter in the target facial attribute determination model based on the at least one target attribute,
where the at least one target attribute is matched with an attribute identifier of the at least one preset facial feature.

According to one or more embodiments of the disclosure, Example 5 provides an image processing method, further including:
constructing a facial attribute determination model to be trained;
obtaining a facial attribute determination model to be used by training the facial attribute determination model to be trained; and
obtaining the target facial attribute determination model by pruning the facial attribute determination model to be used.

According to one or more embodiments of the disclosure, Example 6 provides an image processing method, further including:
constructing a facial attribute determination model to be trained includes:
constructing the facial attribute determination model to be trained, based on an attribute editing sub-model to be trained, a pre-trained target adversarial model, a pre-trained target attribute classification model, and a pre-trained facial matching model,
where the target attribute classification model is configured to determine a facial feature of an image output by the target adversarial model; the facial matching model is configured to determine a matching degree of the facial image output based on the target adversarial model, and the target adversarial model is configured to output two facial images, and one of the facial images is matched with a preset facial feature set in the attribute editing sub-model to be trained.

According to one or more embodiments of the disclosure, Example 7 provides an image processing method, further including:
the target adversarial model includes: a feature preprocessing sub-model and an image generation sub-model. The feature preprocessing sub-model includes a first feature extraction module. The image generation sub-model includes a first image generation submodule and a second image generation submodule. The feature preprocessing sub-model further includes a second feature extraction module.

According to one or more embodiments of the disclosure, Example 8 provides an image processing method, further including:
constructing a facial attribute determination model to be trained includes: determining an output result of the first feature extraction module or the second feature extraction module as an input of the attribute editing sub-model to be trained and the first image generation submodule, determining an output of the attribute editing sub-model to be trained as an input of the second image generation submodule, and determining an output of the first image generation submodule and an output of the second image generation submodule as inputs of the target attribute classification model and the facial matching model to construct the facial attribute determination model to be trained.

According to one or more embodiments of the disclosure, Example 9 provides an image processing method, further including:
obtaining a facial attribute determination model to be used by training the facial attribute determination model to be trained includes:
obtaining a plurality of training samples, where the training sample includes data to be trained;
for the plurality of training samples, inputting the data to be trained in the current training sample to the first feature extraction module or the second feature extraction module to obtain a first feature vector corresponding to the current training sample;
concatenating the first feature vector with an attribute feature vector corresponding to at least one preset facial feature based on the attribute editing sub-model to be trained, to obtain a first attribute feature vector;
inputting the first feature vector to the first image generation submodule to obtain an image without an attribute feature, and inputting the first attribute feature vector to the second image generation submodule to obtain an image with an attribute feature;
inputting the image with an attribute feature and the image without an attribute feature to the target attribute classification model to obtain attribute information to be compared, and inputting the image with an attribute feature and the image without an attribute feature to the facial matching model to obtain facial matching information;
processing the attribute information to be compared, the facial matching information, and the preset facial feature in the attribute editing sub-model to be trained based on a loss function in the attribute editing sub-model to be trained to obtain a target loss value; and
correcting a model parameter in the attribute editing sub-model to be trained based on the target loss value, determining a convergence of the loss function as a training target, and obtaining a facial attribute determination model to be used through training.

According to one or more embodiments of the disclosure, Example 10 provides an image processing method, further including:
obtaining the target facial attribute determination model by pruning the facial attribute determination model to be used includes:
removing the target attribute classification model, the facial matching model, and the first image generation sub-model in the facial attribute determination model to be used, to obtain the target facial attribute determination model.

According to one or more embodiments of the disclosure, Example 11 provides an image processing method, further including:
the preset facial features include at least one of a facial feature about wearing at least one type of accessories, facial features of different age stages, facial features of different angles, facial features of different hairstyles, facial features of different hair color combinations, and facial features of different facial expressions.

According to one or more embodiments of the disclosure, Example 12 provides an image processing apparatus. The apparatus includes:
a data acquisition module, configured to acquire data to be processed, where the data to be processed includes Gaussian noise or an image to be converted; and
a target image determination module, configured to process the data to be processed based on a target facial attribute determination model to obtain a target facial image corresponding to the data to be processed, where at least one target feature in the target facial image is matched with corresponding at least one preset facial feature.

Further, although the operations are described in a particular order, it should not be understood as requiring these operations to be performed in the shown particular order or in a sequential order. In certain environments, multitasking and parallel processing may be advantageous. Similarly, although several implementation details are included in the above discussion, these implementation details should not be interpreted as limitations on the scope of the disclosure. Certain features described in the context of separate embodiments may also be implemented in combination in a single embodiment. Conversely, various features described in the context of a single embodiment may also be implemented separately or in any suitable sub-combination in a plurality of embodiments.

1. An image processing method, comprising:
acquiring data to be processed, wherein the data to be processed comprises Gaussian noise or an image to be converted; and
processing the data to be processed based on a target facial attribute determination model to obtain a target facial image corresponding to the data to be processed, wherein at least one target feature in the target facial image is matched with corresponding at least one preset facial feature.

2. The method according to claim 1, wherein processing the data to be processed based on a target facial attribute determination model to obtain a target facial image corresponding to the data to be processed comprises:
determining a feature vector to be concatenated corresponding to the data to be processed;
concatenating the feature vector to be concatenated with a preset feature vector corresponding to the at least one preset facial feature, to obtain a target feature vector corresponding to the target facial image; and
processing the target feature vector to obtain the target facial image.

3. The method according to claim 2, wherein determining a feature vector to be concatenated corresponding to the data to be processed comprises:
determining a feature vector to be concatenated corresponding to the Gaussian noise based on a first feature extraction module, based on a determination that the data to be processed is the Gaussian noise; and
determining a feature vector to be concatenated corresponding to the image to be converted based on a second feature extraction module, based on a determination that the data to be processed is the image to be converted.

4. The method according to claim 1, wherein after obtaining a target facial image corresponding to the data to be processed, the method further comprises:
determining at least one target attribute corresponding to the target facial image based on a pre-trained attribute classifier, to correct a model parameter in the target facial attribute determination model based on the at least one target attribute,
wherein the at least one target attribute is matched with an attribute identifier of the at least one preset facial feature.

5. The method according to claim 1, further comprising:
constructing a facial attribute determination model to be trained;
obtaining a facial attribute determination model to be used by training the facial attribute determination model to be trained; and
obtaining the target facial attribute determination model by pruning the facial attribute determination model to be used.

6. The method according to claim 5, wherein constructing a facial attribute determination model to be trained comprises:
constructing the facial attribute determination model to be trained, based on an attribute editing sub-model to be trained, a pre-trained target adversarial model, a pre-trained target attribute classification model, and a pre-trained facial matching model,
wherein the target attribute classification model is configured to determine a facial feature of an image output by the target adversarial model, and the facial matching model is configured to determine a matching degree of a facial image output based on the target adversarial model, and the target adversarial model is configured to output two facial images, wherein one of the facial images is matched with a preset facial feature set in the attribute editing sub-model to be trained.

7. The method according to claim 6, wherein the target adversarial model comprises: a feature preprocessing sub-model and an image generation sub-model; the feature preprocessing sub-model comprises a first feature extraction module; the image generation sub-model comprises a first image generation submodule and a second image generation submodule;
and the feature preprocessing sub-model further comprises a second feature extraction module.

8. The method according to claim 7, wherein constructing a facial attribute determination model to be trained comprises:
determining an output result of the first feature extraction module or the second feature extraction module as an input of the attribute editing sub-model to be trained and the first image generation submodule, determining an output of the attribute editing sub-model to be trained as an input of the second image generation submodule, and determining an output of the first image generation submodule and an output of the second image generation submodule as inputs of the target attribute classification model and the facial matching model, to construct the facial attribute determination model to be trained.

9. The method according to claim 7, wherein obtaining a facial attribute determination model to be used by training the facial attribute determination model to be trained comprises:
obtaining a plurality of training samples, wherein the training sample comprises data to be trained;
inputting, for the plurality of training samples, the data to be trained in the current training sample to the first feature extraction module or the second feature extraction module to obtain a first feature vector corresponding to the current training sample;
concatenating the first feature vector with an attribute feature vector corresponding to at least one preset facial feature based on the attribute editing sub-model to be trained to obtain a first attribute feature vector;
inputting the first feature vector to the first image generation submodule to obtain an image without an attribute feature, and inputting the first attribute feature vector to the second image generation submodule to obtain an image with an attribute feature;
inputting the image with an attribute feature and the image without an attribute feature to the target attribute classification model to obtain attribute information to be compared, and inputting the image with an attribute feature and the image without attribute features to the facial matching model to obtain facial matching information;
processing the attribute information to be compared, the facial matching information, and the preset facial feature in the attribute editing sub-model to be trained based on a loss function in the attribute editing sub-model to be trained to obtain a target loss value; and
correcting a model parameter in the attribute editing sub-model to be trained based on the target loss value, determining a convergence of the loss function as a training target, and obtaining a facial attribute determination model to be used through training.

10. The method according to claim 9, wherein obtaining the target facial attribute determination model by pruning the facial attribute determination model to be used comprises:
removing the target attribute classification model, the facial matching model, and the first image generation sub-model in the facial attribute determination model to be used, to obtain the target facial attribute determination model.

11. The method according to claim 1, wherein the preset facial features comprise at least one of following: a facial feature about wearing at least one type of accessories, facial features of different age stages, facial features of different angles, facial features of different hairstyles, facial features of different hair color combinations, and facial features of different facial expressions.

12. (canceled)

13. An electronic device, comprising:
at least one processor; and
a storage apparatus, configured to store at least one program, wherein the at least one program, when executed by the at least one processor, causes the electronic device to:
acquire data to be processed, wherein the data to be processed comprises Gaussian noise or an image to be converted; and
process the data to be processed based on a target facial attribute determination model to obtain a target facial image corresponding to the data to be processed, wherein at least one target feature in the target facial image is matched with corresponding at least one preset facial feature.

14. A non-transitory storage medium comprising computer executable instructions, wherein the computer executable instructions, when executed by a computer processor, cause the computer processor to:
acquire data to be processed, wherein the data to be processed comprises Gaussian noise or an image to be converted; and
process the data to be processed based on a target facial attribute determination model to obtain a target facial image corresponding to the data to be processed, wherein at least one target feature in the target facial image is matched with corresponding at least one preset facial feature.

15. (canceled)

16. The electronic device according to claim 13, wherein the electronic device being caused to process the data to be processed based on a target facial attribute determination model to obtain a target facial image corresponding to the data to be processed includes being caused to:
determine a feature vector to be concatenated corresponding to the data to be processed;
concatenate the feature vector to be concatenated with a preset feature vector corresponding to the at least one preset facial feature, to obtain a target feature vector corresponding to the target facial image; and
process the target feature vector to obtain the target facial image.

17. The electronic device according to claim 16, wherein the electronic device being caused to determine a feature vector to be concatenated corresponding to the data to be processed includes being caused to:
determine a feature vector to be concatenated corresponding to the Gaussian noise based on a first feature extraction module, based on a determination that the data to be processed is the Gaussian noise; and
determine a feature vector to be concatenated corresponding to the image to be converted based on a second feature extraction module, based on a determination that the data to be processed is the image to be converted.

18. The electronic device according to claim 13, wherein after being caused to obtain a target facial image corresponding to the data to be processed, the electronic device to is further caused to:
determine at least one target attribute corresponding to the target facial image based on a pre-trained attribute classifier, to correct a model parameter in the target facial attribute determination model based on the at least one target attribute,
wherein the at least one target attribute is matched with an attribute identifier of the at least one preset facial feature.

19. The electronic device according to claim 13, wherein the electronic device is further caused to:
construct a facial attribute determination model to be trained;
obtain a facial attribute determination model to be used by training the facial attribute determination model to be trained; and
obtain the target facial attribute determination model by pruning the facial attribute determination model to be used.

20. The electronic device according to claim 19, wherein the electronic device being caused to construct a facial attribute determination model to be trained includes being caused to:
Construct the facial attribute determination model to be trained, based on an attribute editing sub-model to be trained, a pre-trained target adversarial model, a pre-trained target attribute classification model, and a pre-trained facial matching model,
wherein the target attribute classification model is configured to determine a facial feature of an image output by the target adversarial model, and the facial matching model is configured to determine a matching degree of a facial image output based on the target adversarial model, and the target adversarial model is configured to output two facial images, wherein one of the facial images is matched with a preset facial feature set in the attribute editing sub-model to be trained.

21. The electronic device according to claim 20, wherein the target adversarial model comprises: a feature preprocessing sub-model and an image generation sub-model; the feature preprocessing sub-model comprises a first feature extraction module; the image generation sub-model comprises a first image generation submodule and a second image generation submodule;
and the feature preprocessing sub-model further comprises a second feature extraction module.

22. The electronic device according to claim 13, wherein the preset facial features comprise at least one of following: a facial feature about wearing at least one type of accessories, facial features of different age stages, facial features of different angles, facial features of different hairstyles, facial features of different hair color combinations, and facial features of different facial expressions.
